(19) United States
(12) Patent Application Publication
(10) Pub. No.: US 2004/0261625 A1
(43) Pub. Date: Dec. 30, 2004

(54) Infant-formula preparation device

(76) Inventor: Vaheed Munir Fowlkes, Scottsdale, AZ (US)

Correspondence Address: Vaheed M. Fowlkes, Apt. 2129, 8275 E. Bell Road, Scottsdale, AZ, 85260, US

(21) Appl. No.: 10/602,155

(22) Filed: Jun. 25, 2003

(51) Int. Cl. A23L 1/00

(52) U.S. Cl. 99/331; 99/427

(57) ABSTRACT

The significant difference that this present invention has compared to prior art is in its individual containers and compartments. These individual containers allow caregivers to differentiate between each infant's dietary constraints. It attempts to simplify the feeding process by providing a method for preparing multiple bottles mechanically. Another benefit comes from the devisee's ability to release each container from its housing so that it may be properly sanitized. The containers may also be brought home, so that parents do not have to worry about leaving formula at their day-care center, where it might be given to another infant. The container can be brought to the day-care center like a child brings his or her lunch box to school. Once there, it can be reinserted and provide a full day's nourishment.

### CROSS-REFERENCE TO RELATED APPLICATIONS:

Patents have been issued that attempt to satisfy the needs of parents and care givers to prepare infant formula by mechanical means. U.S. Pat. No. 5,570,816 issued Nov. 5, 1996 to G. LaBarbara, like other prior art in this field, has answered this need, but unfortunately is suitable only for one or more infants using the same brand of formula, because the patent specifies only one storage compartment for the baby formula. Although this single compartment serves its purpose for one infant, it would be highly impractical to use this devise to feed multiple children who consume different brands of formula. The same can be said for U.S. Pat. No. 5,397,031 issued Mar. 14, 1995 to M. T. Jensen, which also contains only one storage compartment for formula. U.S. Pat. No. 5,419,445 issued May 30, 1995 to D. M. Kaesemeyer and U.S. Pat. No. 5,671,325 issued Sep. 23, 1997 to D. J. Robertson both have one formula storage compartment for the preparation of one infant's dietary needs, but again are highly impractical for feeding multiple infants who need varying brands of formula. The need, therefore, arises for an infant feeding devise capable of providing vital nourishment in one self-contained unit for multiple children who requite different brands and amounts of formula.

### BACKGROUND OF INVENTION

Caring for infants is an arduous task. The stress of caring for just one child can be overwhelming, let alone trying to satisfy the needs of multiple infants whose wails will not ease until proper nourishment has been provided. Couple this with the need to properly sanitize the water and then maintain the balance between hot and cold water to achieve the optimal temperature range vital in infant feeding. This invention can reduce this burden to the press of a few buttons. The water has already been sterilized and maintained at the desired temperature; all that is necessary is for the machine to determine the proper volume and compartment to be released as selected by the user, and—in a matter of seconds—the formula is ready to be served.

Although several patents have been issued for devises that try to satisfy individual needs of preparing baby formula by mechanical means, there is a need to incorporate this idea to serve multiple infants within one devise. Day-care providers generally look after the needs of many infants. Due to the nature of this present invention, it is possible for day-care providers to simultaneously prepare a distinct formula for several different infants.

Once a family has determined the brand of formula to use in their infant's feeding, routine, it is important for that infant to consume that selected brand, unless it is found to cause harm to the infant's digestive system. Therefore, the need arises for a devise to provide each infant with his or her own formula. Unlike other inventions within this field whose storage compartments are designed for one type of formula at one time, this present invention has individual compartments that allow for different types of formula to be stored in the same unit without coming in contact with each other.

Another great benefit this device provides deals with the sanitization of its parts. Past patents have been issued for baby formula preparation devices whose storage containers and methods of measurement are housed within the mechanical workings of the unit. This greatly inhibits the user's ability to properly clean the device. This present invention has been designed to allow the storage container to be removed enabling the entire container to be properly sanitized. Also, the mechanical parts the release the baby formula are either on the surface allowing easy access for cleaning or are void of contact from the baby formula to be released.

### SUMMARY OF THE INVENTION

The present device is a mechanical unit capable of combining various types and amounts of baby formula along with sterilized water with the proper ratio of formula to water on a continuous basis. Due to the device's individual containers, which each have separate compartments, this unit can feed multiple infants several meals each, or one infant the total number of individual meals. This invention significantly reduces the number of steps that day-care providers must take in order to feed the infants in their care, in addition to assisting individual families, who desire to ease the feeding process throughout the day and, especially, throughout the night.

### BRIEF DESCRIPTION OF DRAWINGS:

FIG. 1. Full View Of Baby Formula Preparation Device

FIG. 2. Rotating Container

FIG. 3. Compartment (opened)

FIG. 4. Compartment (closed)

FIG. 5. Compartment Releaser (engaged position)

FIG. 6. Compartment Releaser (latched position)

FIG. 7. Compartment Releaser (retracted position)

1. Electric Control Panel

2. Rotating Assembly Motor

3. Rotating Container

4. Rotating Assembly

5. Formula Dispensing Compartment

a. Notch

b. Retractable Bottom

6. Rotating Bottle Receptacle Motor

7. Chamber Release Valve

8. Compartment Releaser

a. Motor

b. Latch

9. Water Volume Sensor

10. Reservoir

11. Water Temperature Sensor

12. Power Cord

13. Electric Water Heater

14. Rotating Container Motor

15. Water Chamber

16. Reservoir Release Valve

17. Water Tube

18. Baby Formula Funnel

19. Rotating Bottle Receptacle Assembly.

20. Rotating Bottle Receptacle

### DETAILED DESCRIPTION OF DRAWINGS

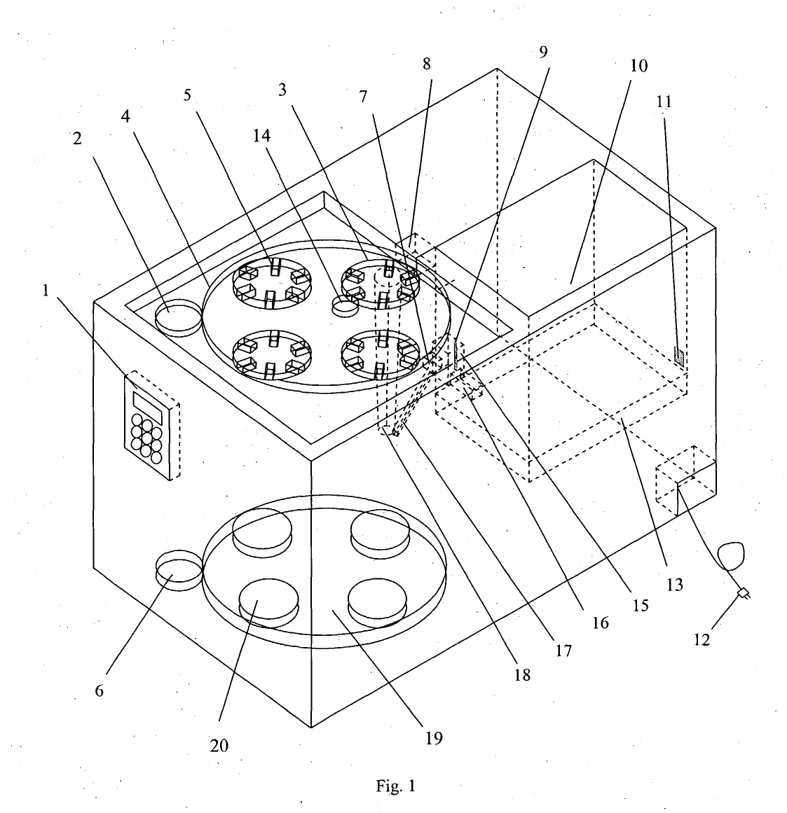

The drawings will be described in the order of operations the device follows in the process of preparing warm baby formula. FIG. 1 is an orthographic view of the entire baby formula preparation device.

First the user fills Formula Dispensing Compartments 5 with baby formula located within each Rotating Container 3. Then the user fills Reservoir 10 with water. Once filled with water, the user selects the temperature they desire for their babies formula on Electric Control Panel 1. The user may also have the option of pressing sterilize, which brings the water to a boil. Electric Water Heater 13 then heats water to desired temperature or to the waters boiling point. Once the water has begun to boil, Water Heater 13 is switched off by Water Temperature Sensor 11, and allows water to cool to desired temperature. When the desired temperature has been reached Water Temperature Sensor 11 and Water Heater 13 communicate to maintain desired temperature for an extended period of time.

When the user is in need of baby formula he or she presses the desired Rotating Container 3 on Electric Control Panel 1. The user then selects the amount of formula to be prepared on Electric Control Panel 1. The process then begins immediately. The water is released through Reservoir Release Valve 16 where it flows into Water Chamber 15. Once Water Volume Sensor 9 detects proper amount of water has been released into Water Chamber 15, Water Volume Sensor 9 closes Water Release Valve 16 and proceeds to open Chamber Release Valve 7. Chamber Release Valve 7 allows water to flow into Water Tube 17; whose mouth has been properly aligned to release its contents directly into bottle.

While the process of expelling sterilized water is taking place, dry baby powder is being maneuvered into position to be released as well.

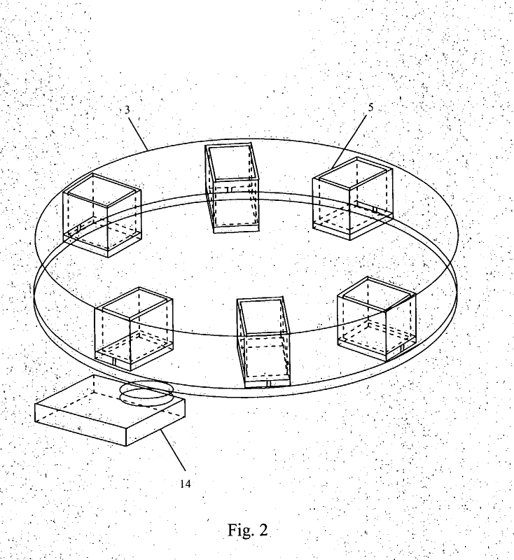

The user has selected the desired Rotating Container 3 therefore; Rotating Assembly 4 is rotated by Rotating Assembly Motor 2 to properly align the selected Rotating Container 3 into proper position. Rotating Container Motor 14 rotates Rotating Container 3 to allow for the proper number of compartments to be released, as seen in FIG. 2.

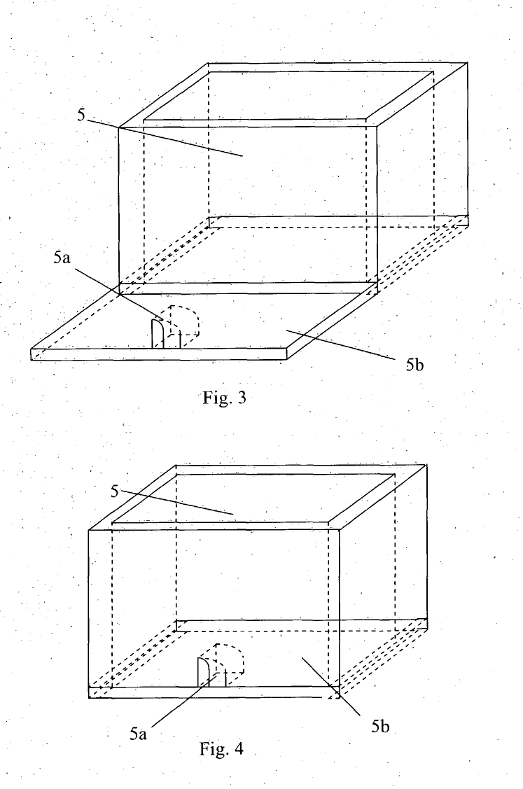

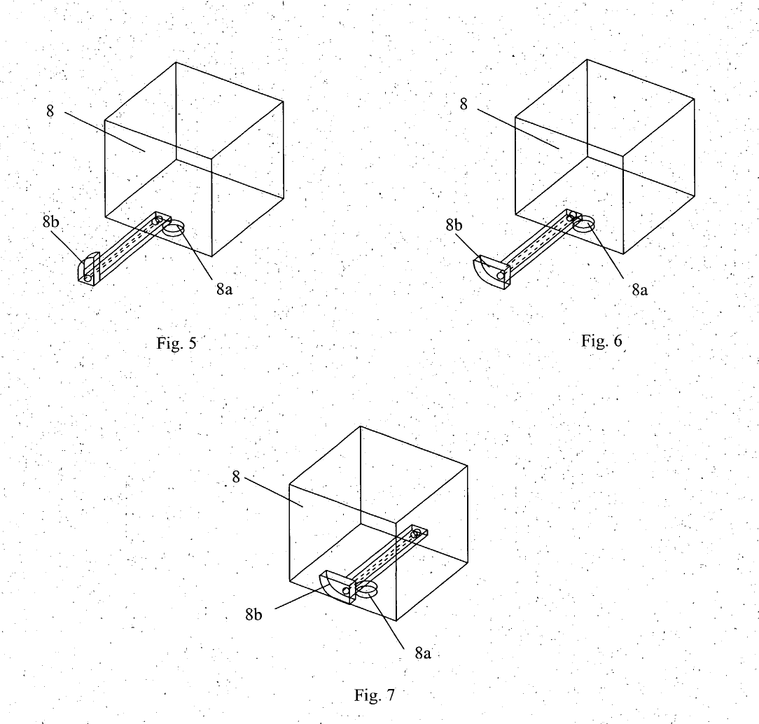

Once in position, Compartment Releaser 8, as seen in FIG. 5, FIG. 6, and FIG. 7 latches onto compartments Retractable Bottom 5b by inserting Latch 8b into Notch 5a, as seen in FIG. 3 and FIG. 4. Latch 8b rotates, fastening itself to compartments Retractable Bottom 5b. Compartment releaser Motor 8a retracts, pulling Retractable Bottom 5b out from underneath Formula Dispensing Compartment 5 allowing powdered formula to be released. Compartment 5's contents fall into Baby Formula Funnel 18, whose mouth is properly aligned to ensure the entire amount of powder is released into bottle resting in Bottle Receptacle 20. Process continues until desired amount of formula has been released to produce pre-selected amount of formula.

Finally, Rotating Bottle Receptacle Assembly 19, under the direction of Control Panel 1, is properly positioned by means of Rotating Bottle Receptacle Motor 6 to ensure both water and powder fall directly into bottle which rests in Bottle Receptacle 20.

All electronic steps are made possible by Power Cord 12, which is inserted into wall outlet. Power Cord 12 provides Electric Control Panel 1, Water Volume Sensor 9, and Water Temperature Sensor 11 with electricity needed to regulate the flow of electricity, thus enabling electronic functions to be executed.

I claim:

1. An electronically controlled baby formula-dispensing unit comprising;
a rotating assembly with individual rotating containers;
a said rotating container with multiple compartments, each of which open individually to dispense said compartment's contents while maintaining the other said compartments contents;
a mechanically driven means of rotating said assembly;
a mechanically driven means of rotating said container;
a mechanically driven means of releasing said compartments' said contents.

2. An electronically controlled baby formula-dispensing unit also comprising;
a reservoir capable of storing water;
a heating devise capable of boiling water within said reservoir;
a sensor capable of detecting water's temperature and maintaining its predetermined optional temperature range;
a tube capable of housing water to allow its flow from said reservoir to end of said tube;
a valve capable of opening and closing to release or contain said reservoirs' said contents.

3. An electronically controlled baby formula-dispensing unit also comprising;
a rotating assembly capable of serving bottles;
a means of rotating said assembly to allow for bottles' openings to be properly aligned with said tube and said compartment to assure that all said contents released are properly contained within the bottle.
